(19) United States
(12) Patent Application Publication
(10) Pub. No.: US 2017/0112101 A1
(43) Pub. Date: Apr. 27, 2017

(54) Dogpers

(71) Applicant: Louise C. Clark, Croton-on-Hudson, NY (US)

(72) Inventor: Louise C. Clark, Croton-on-Hudson, NY (US)

(21) Appl. No.: 14/918,858

(22) Filed: Oct. 21, 2015

(51) Int. Cl. A01K 23/00

(52) U.S. Cl. CPC A01K 23/00

(57) ABSTRACT

The present invention provides a diaper for male and female dogs, and, in particular, for an incontinent dog. The diaper could cover the back of dog and extend to the stomach, wherein the Velcro is used to wrap the diaper around the stomach of the dog. The diaper has an aperture for the tail of the dog and could prevent any leakage of urine.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The present invention generally relates to diapers, and, in particular, to diapers for male dog, but can be used for female dog.

(2) Background of Invention

Diapers currently available in the market do not fit all dogs, in particular large-size male dogs. Such diapers are not suitable for dogs with urinary incontinence. Typically, the diaper covers the male parts of the dog, and the urine seeps out of the diaper, creating a mess. Prior art disclosing extra-large diapers include published U.S. patent application Ser. No. 12/803,266 entitled “Adjustable male dog diaper wrap,” U.S. Pat. No. 5,234,421, issued to “Joy Lowman,” entitled “Diaper for incontinent dogs,” U.S. Pat. No. 7,174,860, issued to “Pedigree Perfection,” entitled “Disposable animal diaper,” and U.S. Pat. No. 6,368,313, issued to “Sandra K. Howard,” entitled “Dog diaper system.” A need exists for an improved diaper especially for male dogs and incontinent dogs.

### SUMMARY OF THE INVENTION

The present invention, therefore, has as its principal objective to provide a diaper for male dogs of all sizes and would also work for female dogs.

Another objective of present invention is that the diaper is suitable for male and female dogs of all size.

An additional objective of present invention is that the diaper could be used for incontinent dogs.

Yet another objective is that the diaper is easy to put on and remove.

Certain embodiments of current invention provide a diaper for male dogs but can also be used for female dogs, that is comprised of a pull up and two human diapers. One of the diapers is coupled to the pull up, while the other diaper is also coupled, but in reverse order, such that Velcro could wrap around the stomach of the dog. Thereafter, a hole is made in the pull up for the tail of dog. The diaper covers both the male and female parts and wraps around stomach of the dog through Velcro straps, which prevents seepage of urine.

In addition to the various objectives and advantages of the present invention, described with some degree of specificity above, it should be obvious that additional objectives and advantages of the present invention will become more readily apparent to those persons who are skilled in the relevant art from the following more detailed description of the invention.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof which are illustrated in the appended drawing. It is appreciated that the drawings depict only illustrated embodiments of the invention and are therefore, not to be considered limiting of its scope. The invention will be described and explained with additional specificity and detail through the use of the accompanying drawing in which:

FIG. 1 depicts a perspective view of the invention.

### DETAILED DESCRIPTION OF THE INVENTION

The present invention provides a diaper for male and female dogs and incontinent dogs, wherein an improved design of the diaper prevents any leakage of urine.

Before explaining at least one embodiment of the invention in detail, it is to be understood that the invention is not limited in its application to the details of construction and the arrangements of the components set forth in the following description. The invention is capable of other embodiments, and of being practiced and carried out in various ways. Also, it is to be understood that the phraseology and terminology employed herein are for the purpose of description, and should not be regarded as limiting.

As used in this specification and the appended claims, the singular forms “a”, “an”, and “the” include plural referents, unless the content clearly dictates otherwise. Thus, for example, reference to a composition containing “a compound” includes a mixture of two or more compounds. As used in this specification and the appended claims, the term “or” is generally employed in its sense including “and/or,” unless the content clearly dictates otherwise.

Unless otherwise defined, all terms (including technical and scientific terms) that are used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense, unless expressly so defined herein.

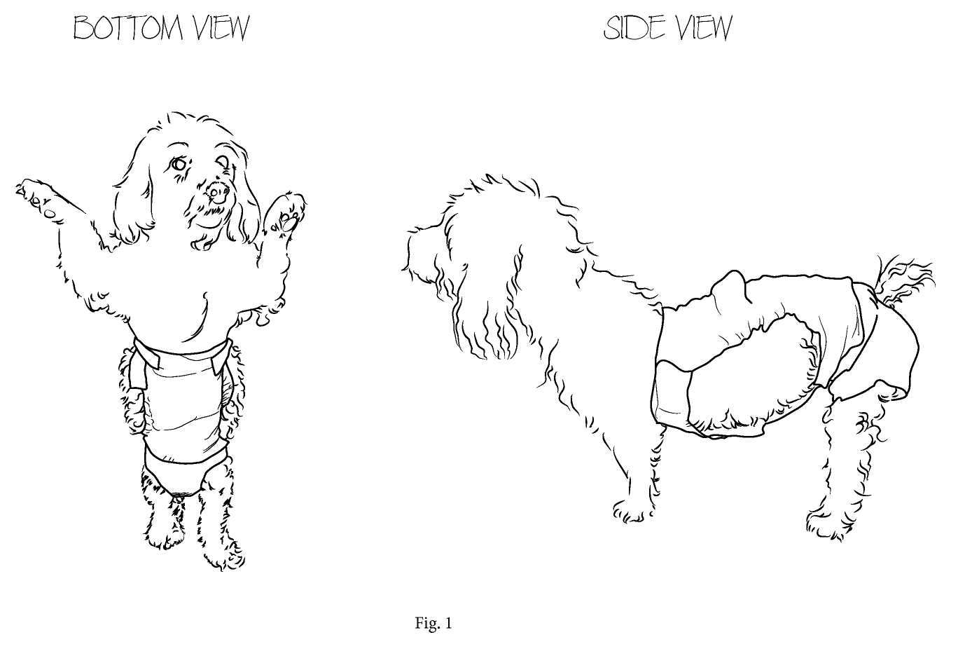

Referring to FIG. 1, the present invention is a disposable sanitary diaper for male and female dogs. The diaper covers the back of the dog and extends to the stomach such that it covers the male parts of the dog and prevents any leakage of urine. The disposable diaper further has an aperture for the tail of the pet. The disposable diaper is further comprised of a hook and look fastener to wrap the diaper around the stomach of the dog.

An improved design of diaper prevents urine from seeping, and, in particular, is useful for incontinent dogs. The disposable diaper could be made from two ordinary human diapers and a pull up. One of the diapers could be coupled to the pull up while the other diaper is also coupled, but in reverse order than the first diaper. This allows the Velcro of the diaper to be wrapped around the stomach of the dog. The diaper could be used overnight, and, thus, provide convenience to both the dog and the person.

Those skilled in the art should appreciate that they can readily use the disclosed conception and specific embodiment as a basis for designing or modifying other structures for carrying out the same purposes of the present invention, and that such other structures do not depart from the spirit and scope of the invention in its broadest form.

I claim:

1. A diaper for male and female dogs comprising:
a. a pull up;
b. two human diapers;
said one unit of diaper is coupled to the pull up; the other diaper is also coupled but in reverse order, such that the Velcro of the diaper could wrap around the stomach.

2. The diaper of claim 1, wherein said pull up has a hole for tail of the dog.

3. The diaper of claim 1, wherein said dog is incontinent of any size.

4. A method of putting a diaper on the dog, said method comprises coupling a human diaper to a pull up, coupling another human diaper to the pull up but in reverse order, making a hole in the pull up to accommodate a tail of the dog, putting the diaper on the back of the dog and passing the tail through the hole, extending the diaper up to the stomach, and wrapping a Velcro strip of the diaper around the stomach of the dog.

5. The method of claim 4, wherein said dog is a male and female dog.

6. The method of claim 4, wherein said dog is an incontinent dog of a any size.
